(19) United States
(12) Patent Application Publication
(10) Pub. No.: US 2025/0288965 A1
(43) Pub. Date: Sep. 18, 2025

(54) ENHANCED MIXING DEVICE AND METHOD OF MIXING

(71) Applicant: Thomas Edwards, Other (GB)

(72) Inventor: Thomas Edwards, Other (GB)

(21) Appl. No.: 18/862,586

(22) PCT Filed: Apr. 23, 2023
(86) PCT No.: PCT/IB2023/054194

§ 371 Date: Nov. 4, 2024

Related U.S. Application Data
(60) Provisional application No. 17/744,836, filed on May 16, 2022.
(60) Provisional application No. 18/115,003, filed on Feb. 28, 2023.

(30) Foreign Application Priority Data
May 3, 2022 (GB) 2206410.9
Jan. 17, 2023 (GB) 2300652.1
Apr. 23, 2023 (WO) PCT/IB2023/054194

(51) Int. Cl. B01F 31/20; B01F 35/222; B01F 35/42

(52) U.S. Cl. CPC B01F 31/265; B01F 35/222; B01F 35/42

(57) ABSTRACT

A mixing device of FIG. 1B comprises a multi-element spring system in which an eccentric load, coupled to a rotor of a motor, is located towards a first end of a first beam realising a backbone for the mixing device. One or more connections interconnect the backbone respectively to one or more other beams to produce the multi-element spring system. A load, such as a vial or other container in which is located a diluent, is located remotely from the motor. As such, the spring system supports two independent but complementary eccentric load generating subsystems arising from, respectively, the controlled rotation of the rotor [and its eccentric load] and then, in response to rotation of the connected eccentric load on the rotor, swirling of the diluent in the vial/container. Both these eccentric loads contribute to a complex multidirectional flexing of the multi-element spring system [relative to a fixed anchor point].

### TECHNICAL FIELD

This invention relates, in general to a mixing device and method of mixing. More particularly, but not exclusively, the invention relates to a mixer for mixing solids and liquids or for reconstitution, especially in the context of preparing pharmaceutical preparations in which a diluent is introduced into a vial containing a sterile compound, such as a crystalline or powdered form, requiring homogeneous mixing for sometimes just-in-time ‘water clear’ dissolution. However, the present invention has wider applications, especially for relatively small-volume mixing (including dissolving, diluting or suspending) and irrespective of whether base ingredients are in liquid into liquid or otherwise, and finds applications in household mixers for cosmetics, such as nail varnishes, tattoo inks and the like, food mixing (such as needed in the preparation of nutritional drinks or liquid mixable supplements), and also in veterinary science for the preparation of medicaments.

### BACKGROUND ART

As it is known, drugs are frequently stored in powdered form (lyophilized) because they may rapidly degrade and consequently lose their efficacy once they are mixed into a solution. Powdered drugs are typically used for parenteral administration. These powdered drugs or medicines are often labelled to as “Powder for solution for infusion” and “Powder for solution for injection”. Additionally, orally administered medicines are often liquid/solid suspensions within which ingredients settle or otherwise separate over time during storage.

The above powdered drugs need to be mixed in a container (normally a vial) with a liquid generally referred to as “the diluents”, i.e., reconstituted. The above liquid suspension medicines often require manual mixing to homogenise or dissolve the medicine before administration.

Once the diluent has been added to the powdered drug, the liquid-powder mixture needs to be agitated in the container until the drug powder is dissolved, i.e., the reconstitution process is complete. For instance, the United States Pharmacopoeia “USP” [2006] defines completeness of reconstitution as the state where the solid dissolves completely, leaving no visible residue as un-dissolved matter or the constituted solution is not significantly less clear than an equal volume of the diluent or purified water present in a similar vessel and examined under similar conditions.

For medicines in suspension form, there is generally an instruction to “shake well before use” without a means of inspection of completeness of mixing, or if there are specific movements required to achieve acceptable mixing. For medicines and drugs delivered by spray a similar general “shake well before use” is often included in the in-structions, but this instruction is itself subjective so can be interpreted differently by different people or otherwise it may be ignored.

Currently available solutions to the problem of effective mixing, whether in drug reconstitution [as is used as a particular example throughout this description] or for other products requiring mixing industrially or at home, are either focused on automated system whose aim is to optimize the agitation process to achieve the best dissolution and/or mixing for drug reconstitution in the shortest time, or otherwise are manual in nature.

Automated/mechanical systems available on the market perform agitation using the following movements: rotating the container around its longitudinal axis; rotate the container around a central axis of a rotating disk where the container has their longitudinal axis parallel or inclined or orthogonal to such rotation axis; shaking container with variable frequency or with variable amplitude; and inducing a vortex within the diluents by means of a mixing tool immersed in the diluents.

Manual mixing methods, such as shaking and swirling, are often performed by a person, such as a nurse or pharmacist technician. The time to achieve effective mixing could take from few seconds to several minutes. A person would not be able to manually repeat a complex movement for such a long time to achieve a consistent result and in a readily repeatable manner. Indeed, the subjective nature of mixing, even by a professional healthcare worker, can or does result in a possibility for poor distribution of the active medicinal ingredients prior to administration to the patient.

Indeed, current practices relating to the preparation of medicaments, especially for just-in-time pharmaceuticals, are unreliable and/or labour intensive and, in fact, have several specific issues associated with production of an effectively mixed preparation.

For example, sterility of the components of the medicament, whether liquid or solid or a mixture, must be maintained. This means that vials are preferably permanently sealed, and a diluent introduced through seal penetration to avoid air exposure rather than by opening. Magnetic or physical mixing approaches in which respectively a magnetic stirrer or rod is introduced into the vial are each further frowned upon for reasons that the stirrer/rod is a foreign body and an additional cost item, and both potentially compromise sterility depending upon how the foreign body was prior treated or introduced.

In some instances, the mixing of certain drugs is frequently if not entirely conducted by hand because there is no effective mixer on the market. Such hand mixing is a spe-cialised skill requiring: (a) mastery to produce the requisite swirling technique in the vial contents, (b) physical stamina, and (c) diligence. To provide a contextual example, the drug Tazocin® is notoriously difficult to mix and takes more than ten minutes to mix to a “water clear” state in which there are no visually identifiable particulates. Such human processing can lead to (a) repetitive strain injury, and/or (b) sub-optimal mixing and thus (c) sub-optimal dosing arising from a lack of objectivity in production. At least some of these mixing issues result in questions surrounding reconstituted drug efficacy and thus patient outcome issues.

The time-consuming nature of by-hand drug reconstitution is exacerbated by a lack of staff, while the costs associated with ineffectual and/or inefficient manual mixing are considerable. Neither of these problems lead to value-based healthcare.

The need for “just-in-time” drug reconstitution requires local, time-critical drug reconstitution. This requires a trained healthcare worker to be on hand, and that is not always possible because of the time of day or the location where reconstitution is required.

An efficient mixing device and related method for effectively constituting or recon-stituting drugs or, more generally, mixing device that achieves effective mixing of other commodities, such as household paints, varnishes, food products and the like, in a consistent and repeatable manner is needed.

### SUMMARY OF INVENTION

According to a first aspect of the invention there is provided a mixing device comprising: a rotating actuator carrying an eccentric load; a controller exercising parameter control defining operation of the rotating actuator and instantaneous amounts of energy provided, at least in part, to the mixing device through controlled rotation of the eccentric load; a mount configured to hold securely the rotating actuator; a clamp configured to hold a mixing container representing a mass, wherein the mixing container includes at least one liquid as part of assembled container contents; a multi-element spring containing a plurality of conjoined beams each providing at least one degree of motion, the multi-element spring including: a principal beam having a proximal end and a distal end, the principal beam separating the proximal end from the distal end, wherein the actuator mount and rotating actuator are securely coupled substantially at the proximal end and the lateral side plate undergoes flexion movement consequential to controlled rotation of the eccentric load; a second beam fixed, through a first substantially rigid hinge, to the distal end of the principal beam, wherein the second beam extends relatively outwardly from the principal beam and wherein the first substantially rigid hinge permits flexion movement of the second beam relative to the principal beam and the second beam further securely holds the clamp and, in use, the mixing container; a third beam fixed, through a second substantially rigid hinge, to a part of the principal beam, the third beam both extending relatively outwardly from the principal beam and in a different orientation relative to orientation of the first substantially rigid hinge, and wherein: outward extension of the third beam increases from the second substantially rigid hinge across a width of the third beam; and the third beam is arranged to permit, when in use and further connected to a stable bracing structure, differing amounts of flexion movement along the second substantially rigid hinge.

In embodiments of the invention, the controller is arranged to operate in at least two phases differentiated between an initial phase that transitions to a kick-phase in which kick-phase an energy profile delivered by parameter control of the rotating actuator is changed significantly relative to that in the initial phase.

The initial phase induces a motion in the assembled container contents in the attached mixing container and the kick phase is arranged to produce a high-speed swirling motion, which may also resemble a vortex, in the assembled container contents. The swirling motion may also be gradually produced.

In embodiment, the controller can be arranged to change rotational speed of the rotating actuator and eccentric load to generate varying rates of swirling. Further selected parameter control of the actuator can include control of at least one of: the duty cycle in a pulse width modulated signal controlling rotation of the rotating actuator and eccentric load; and voltage delivery to a motor of the rotating actuator to affect a change in current through the motor. As described herein, the controller may control operation of the rotating actuator so as to control delivery of energy to the system until full mixing or dissolution of contents within the mixing container is attained.

In described embodiments, the controller is arranged to instantiate an initial phase that induces a chaotic motion by shaking the assembled container contents in the attached mixing container, and then at least a secondary phase that induces swirling motion in the assembled container contents.

Within the various described embodiments, the controller is arranged to operate to control delivery of energy to the mixing device, as delivered by operation of the rotating actuator, which has a function that includes at least one of: a linear variation in delivered energy; an exponential variation in delivered energy; and a non-linear variation in delivered energy.

According to the invention, movement of the assembled container contents represents a secondary eccentric load inducing additional flexion movement through generation of dynamic bending forces within the multi-element spring arising from time-varying loads operating at the proximal end and distal end of the principal beam.

Preferably, the multi-element spring is of unitary construction, such as being molded as a single piece of plastics material.

In another aspect of the invention there is provided a mixing device comprising: a rotating actuator supporting a first eccentric load, the rotating actuator responsive to a control program defining how energy is imparted into the mixing device through time-varying rotation control of the first eccentric load; and a multi-element spring containing a plurality of conjoined beams each providing at least one degree of motion within differing planes of motion for each of the plurality of conjoined beams, and wherein at least one pair of the plurality of conjoined beams is coupled together by a substantially rigid hinge, and wherein one of the plurality of the beams is a backbone having: a first end to which the rotating actuator and the first eccentric load are securely fixed; and a second end remote to the first end and where a clamp for securing, in use, a mixing container, the clamp proximate the second end and separated from the first end; wherein the multi-element spring is arranged to flex in multiple degrees of freedom in response to a combination of active and reactive forces caused and induced by the rotation of the first eccentric load at the first end and a secondary eccentric load held proximate to the clamp, the secondary eccentric load substantially induced by rotation of the first eccentric load and wherein the secondary eccentric load produces reactive force at least partially through the backbone.

A second conjoined beam of the plurality of the beams has variable stiffness longitudinally effective along a length of the substantially rigid hinge connecting the second conjoined beam to the backbone.

In a further aspect of the invention, there is provided a mixing system in combination with a sealed vial realising the mixing container, wherein the sealed vial is internally sterile and contains a sterile compound to be dissolved, diluted or suspended in or by a sterile diluent introduced into the vial by means of seal penetration.

In another aspect of the invention there is provided a method of dissolution or homogeneous mixing of a sterile compound or solid into a diluent or liquid introduced into a sterile vial initially containing (a) the sterile compound or sterile solid and (b) gas, the method comprising: generating multiple time-varying dynamic multi-directional flexing in individual elements of a multi-element spring of a mixer to induce a swirling motion of the diluent in the vial, wherein the motion initially in the diluent is produced by selectable motor-driven rotation of a first eccentric load of the mixer at a proximate first end of a first element of the multi-element spring of the mixer whilst the vial is securely fixed at or near a remote second end of the first element, and time-varying dynamic multi-directional flexing within the elements of the multi-element spring is relative to a substantially motionally-stable bracing point to which one element of the multi-element spring is securely fixed; and controllably causing a change in energy to be imparted into the multi-element spring by changing operational parameters of a motor driving said rotation of the first eccentric load to cause at least swirling to form within the diluent in the sterile vial.

In the method, swirling precedes formation of a vortex within the contents of the sterile vial. Furthermore, movement of the contents in the vial represents a secondary eccentric load that induces compound flexing through generation of dynamic bending forces within elements of the multi-element spring, said compound flexing arising from at least differing positions for time-varying loads applied at the separated proximal end and the distal end of the first element.

In a preferred method of dissolution or homogeneous mixing, mixing is facilitated by causing a change in rotational velocity in the contents in the vial through rotational speed of the first eccentric load. The change in rotational velocity may be caused by at least one of: a change in duty cycle in a pulse width modulated signal controlling rotation of the first eccentric load; a change in the frequency modulation rate; and a change in voltage delivered to a motor controlling rotation of the first eccentric load to affect a change in current in the motor. Preferably, the method sees the exercise of controlled delivery of energy to the mixer until mixing or dissolution of contents within the mixing container is attained.

In yet another aspect of the invention there is provided a method of dissolving or diluting or suspending a compound with a diluent introduced into a mixing container firmly held in a mixer, the method comprising:
combining the diluent and compound in the mixing container to produce a mixture;
initially shaking or swirling the mixture by dynamically flexing multiple elements of a multi-element spring in different planes of motion, said flexing initially caused by a rotation of a first eccentric load by a rotating actuator at a first end of a principal structural element of the multi-element spring, said shaking or swirling the mixture resulting from the multi-plane flexing of the principal structural element connected by at least a first connection to a reference structural element; and the reference structural element also flexing relative to a stable bracing structure;
a microprocessor-based controller exercising parameter control defining operation of the rotating actuator and instantaneous amounts of energy provided to the mixing device through controlled rotation of the first eccentric load; and
by action of said rotation, inducing a complementary secondary flexing in the multi-element spring through swirling or shaking the mixture, the complementary secondary flexing producing a spatially distant second eccentric load, the spatially distant second eccentric load produced at the mixing container, the mixing container held securely by a clamp, and the clamp securely fixed at or adjacent to a second end of the principal structural element; and
controllably changing or maintaining motion of the first eccentric load at the first end to deliver energy to the mixer.

The mixing container may be one of: an open-topped container; a sealable container having a replaceable top or cap; and a pre-sealed container containing contents and wherein the pre-sealed container can be penetrated to introduce the diluent.

In a another aspect of the invention there is provided a mixing device comprising: a multi-element spring containing a plurality of conjoined beams each supporting multiple planes of motion, wherein at least one pair of the plurality of conjoined beams is coupled together by a substantially rigid hinge and said at least one pair comprises: a backbone beam having a first end arranged to hold securely a rotating actuator supporting a first eccentric load, and a second end remote to the first end, the second end including a clamp for securing, in use, a mixing container; and a reference beam conjoined to the backbone beam along a substantially rigid hinge, wherein the reference beam extends relatively outwardly from the backbone beam and the reference beam has variable stiffness longitudinally effective along the substantially rigid hinge, wherein the multi-element spring is arranged to flex in multiple degrees of freedom in response to a combination of complementary forces arising from rotation of the first eccentric load and a secondary eccentric load held in the clamp, the secondary eccentric load substantially arising in response to rotation of the first eccentric load.

The reference beam may be inclined relative to the backbone beam by an angle in the range of about five degrees to about ninety degrees. The angle is dependent upon the variable stiffness of the reference beam. In a preferred arrangement, the relative movement of the reference beam to the backbone beam is differential. In one or more embodiments described herein, the reference beam is comprised of a plurality of discrete elements having different stiffnesses.

Optionally, at least one of the plurality of conjoined beams can include one or more material reliefs defining varying geometry within or at the surface of the beam. The material relief is at least one of: an edge cut-out; a hole; a channel; variable length; and variable thickness.

In another aspect of the invention there is provided a mixing device comprising: a rotating actuator carrying an eccentric load; a controller exercising parameter control of the rotating actuator to control energy provided, at least in part, into the mixing device through controlled rotation of the eccentric load; a mount configured to hold the rotating actuator; a clamp configured to hold a mixing container representing a mass, when in use the mixing container includes at least one liquid as part of assembled container contents; a multi-element spring containing a plurality of conjoined beams each providing at least one degree of motion, the multi-element spring including: a principal beam having a proximal end, a distal end and a bottom edge, wherein the mount and rotating actuator are securely coupled substantially at the proximal end of the principal beam; a second beam fixed, through a first substantially rigid hinge, to the distal end of the principal beam, wherein the second beam extends relatively outwardly from the principal beam and wherein the first substantially rigid hinge permits flexion movement of the second beam relative to the principal beam and the second beam further holds the clamp; and a third beam fixed, through a second substantially rigid hinge, to a part of the bottom edge of the principal beam, the third beam extending relatively outwardly from the principal beam, and wherein; the third beam is arranged to permit, when in use and further connected to a stable bracing structure, differing amounts of flexion movement along the second substantially rigid hinge.

There is also disclosed herein a mixing system comprising the mixing device of the various aspects (and numerous preferred embodiments), wherein the second conjoined beam is securely fixed to a stable reference structure and the second conjoined beam, in use, is arranged to flex relative to the stable reference structure.

There is also disclosed, a multi-element spring wherein at least one combinatorial connection is substituted for a substantially rigid hinge connected to a beam; the substantially rigid hinge is enabled within the form of a curved beam to realise the functionally equivalent combinatorial connection.

There is also disclosed a mixing device comprising a rotating actuator carrying an eccentric load, a controller exercising parameter control defining operation of the rotating actuator and instantaneous amounts of energy provided, at least in part, to the mixing device through controlled rotation of the eccentric load, a mount configured to hold securely the rotating actuator, a clamp configured to hold a mixing container, wherein the mixing container includes at least one liquid as part of assembled container contents, a multi-element spring containing a plurality of structural elements connected to each other by an at least one connection, the at least one connection supporting a relative dynamic change in orientation between connected structural elements when under dynamic load, the multi-element spring including, a principal structural element having a proximal end and a distal end, wherein the mount and rotating actuator are securely coupled substantially at or towards the proximal end and, at or towards the distal end, the clamp is fixed such as to hold, in use, the mixing container securely into the mixing device, a reference structural element connected, through a first connection, to a part of the principal structural element, the reference beam both extending relatively outwardly from the principal structural element and in a different orientation relative to an orientation of the principal structural element, wherein the reference structural element has a shape designed to permit, when in use and further connected to a stable bracing structure, differing amounts of flexion movement relative to the stable bracing structure

There is also disclosed a mixing device of the previous paragraph, wherein a support structural element is interposed between the distal end of the principal structural element and the clamp, the support structure both extending relatively outwardly from the principal structural element and in a different orientation relative to the orientation of the principal structural element and wherein the clamp is affixed to the support structural element.

There is also disclosed a mixing device wherein at least two of, the principal structural element, the reference structural element, the support structural element, the clamp; and the mount, are formed as a continuous object.

For clarity, it will be readily understood that a structural element may also be combinatorial connection or a beam or a cantilever beam or an arrangement of conjoined elements arranged to behave as a beam or beams or a system of beams, or be a functional equivalent such as, for example, a lattice structure.

In broad term, an aspect of the present invention relates to a system for mixing or dissolving one or more ingredient(s) or compounds with a liquid, the system comprising: a container holding said one or more ingredient(s) or compounds and the liquid; a mixer having: (a) a plurality of beams each interconnected by a substantially rigid hinge wherein a combination of beams and hinges or combinatorial connections form a multi-element spring in which, under applied motor-induced forces, at least: some of said plurality of beams and/or combinatorial connections flex or bend in one or more planes of motion, and some of said plurality of beams and/or combinatorial connections undergo relative angular displacement or relative linear displacement in differing planes of motion for said beams; and (b) two eccentric loads located remote from each other but attached to the multi-element spring, wherein: a first eccentric load is an eccentric mass on a rotor of a controllable motor; and a second eccentric load is created by agitation of said one or more ingredient(s) or compounds and the liquid, said agitation following flexing and displacement of the multi-element spring consequential of motor-induced forces introduced into the multi-element spring by controlled operation of the motor.

Advantageously, the present invention in its various guises and embodiments provides a mixer that can achieve dissolution/homogenous mixing more rapidly and generally better mixing for medicament preparations and other small-volume emulsions or solutions. The concepts of the present invention, however, may be scaled for larger volume mixing.

The present invention thus provides a new and improved mixer. Generally speaking, the mixer includes a combination of connected sprung beams or cantilevers connected through substantially rigid hinges or a functional equivalent(s), with the structure preferably manufactured as a one-piece integral molding. The mixer is driven by a motor with an eccentric load that, upon rotation, induces twisting and flexing forces through the entirety of the multi-element spring. A portion of the spring system is however adapted to be braced. The beams produce multi-plane/multiple degrees of movements within the multi-element spring which, when in use, translate to the contents of, for example, a vial which is capable of being firmly but removably attached to the mixer. Hence, when in use, the contents of the vial undergo mixing where the nature and direction of the mixing is governed by the multiple plane/multiple degrees of freedom of motion.

Once swirling movement is induced in the content (from the sum of flexing forces induced by the programmable operation of the motor and movement of the eccentric load), the moving contents act as a complementary (reinforcing or destructive) secondary eccentric load. The system thus experiences complex complementary twisting forces emanating from the vial which further complicate the movement within the multi-element spring. A second trigger event, controlled by operation of the motor, can be employed to induce, in the limit, the formation of a vortex in the contents of the vial. The overall arrangement has been proven to establish effective mixing.

Depending on the forces generated by the rotation of motor shaft and associated eccentric mass on the rotor, the combination of forces resulting from moving the contents within the vial/container and the forces generated by arrangement of the sprung beams, a number of generally recognisable fluidic motions can be achieved within the vial. The recognisable fluidic motions include at least shaking, vibrating, swirling and vortex.

### BRIEF DESCRIPTION OF DRAWINGS

Exemplary embodiments of the present invention will now be described with reference to the accompanying drawings, in which:

In [FIG. 1]; FIGS. 1A and 1B show different perspectives views of a mixing device according to a preferred embodiment of the present invention.

FIG. 2 and [FIG. 3] show and reflect dimensionality for a working example of the mixing device of FIGS. 1A and 1B.

FIG. 4 and [FIG. 5] show different perspectives views of a mixing device according to a first alternative structural arrangement.

In [FIG. 6]; FIGS. 6A, 6B and 6C show different perspectives and exploded views of a mixing device according to a second alternative structural arrangement.

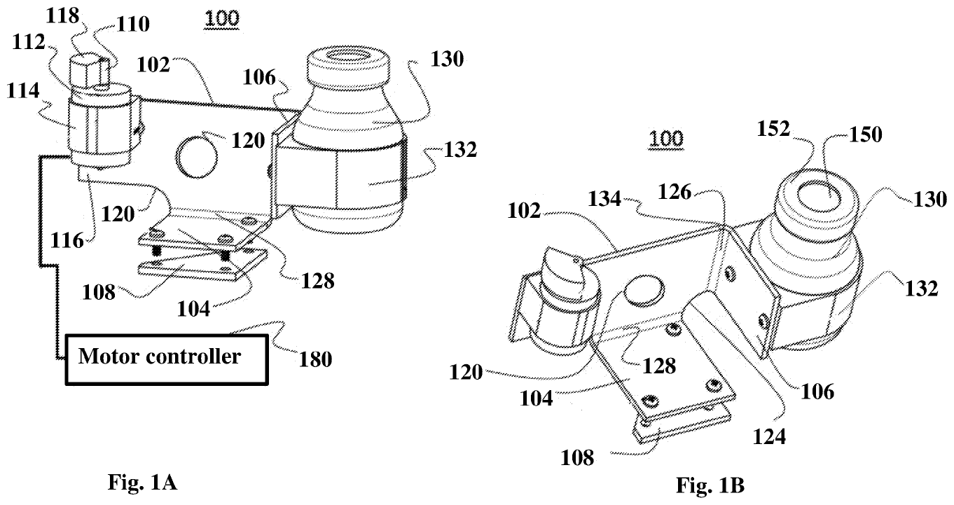

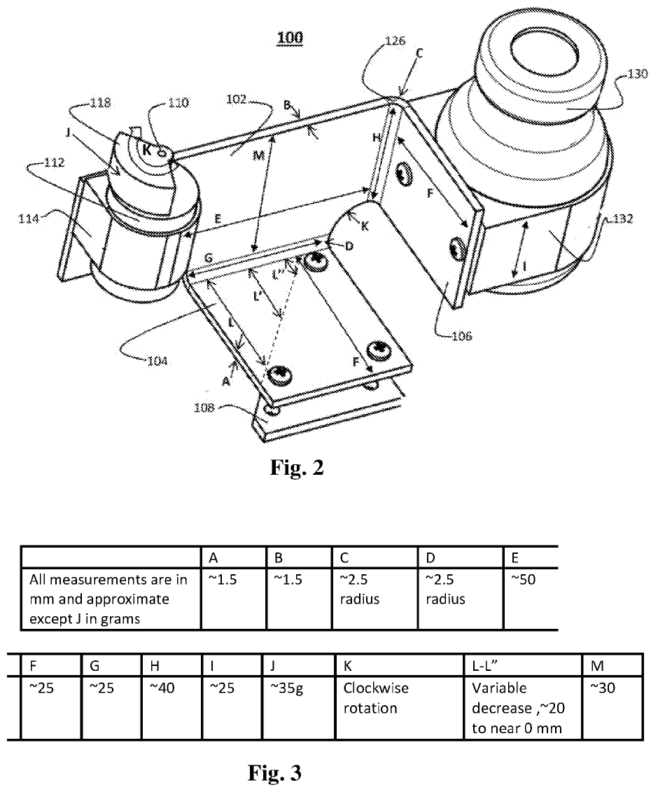

In [FIG. 7]; FIGS. 7A to 7C, in [FIG. 8]; FIGS. 8A to 8C and in [FIG. 9]; FIGS. 9A to 9C show an FEA approximation, over time and under applied directional force, of relative movement of the various components, beams and hinges, respectively, of the mixer system and the multi-element spring [FIG. 2].

In [FIG. 10]; FIGS. 10A to 10E show a succession of photographic images captured using a high-speed digital camera for in-cycle operation of the mixing device manufactured in accordance with the design of [FIG. 2].

In [FIG. 11]; FIGS. 11A to 11E show a succession of captured images on which developing orbital motions for identified features on a mixing device, manufactured in accordance with the design of [FIG. 2], have been mapped by tracking software.

In [FIG. 12]; FIGS. 12A and 12B show a primitive representation of a mixing device according to two alternative structural arrangements functionally equivalent respectively to a two-beam arrangement of [FIG. 6] and a three-beam mixer arrangement of FIGS. 1A and 1B.

In [FIG. 13]; FIGS. 13A to 13C shows alternate functionally equivalent hinge and beam structures that produce the substantially rigid hinge and associated conjoined beams of [FIG. 1] and other figures.

In [FIG. 14]; FIGS. 14A to 14C show different views of an alternative functionally equivalent arrangement of a three-beam mixer incorporating one or more substantially rigid hinge, with FIGS. 14A to 14C realizing other alternative structural arrangement of a multi-element spring of the invention.

In [FIG. 15]; FIGS. 15A and 15B show different views of yet another alternative functionally equivalent arrangement of a two-beam mixer incorporating at least one substantially rigid hinge and conjoined beam, with FIGS. 15A and 15B realizing other alternative structural arrangement of a multi-element spring of the invention.

In [FIG. 16]; FIGS. 16A and 16B show an FEA approximation, with respect to time and applied directional force, describing relative movement of the various components of the multi-element spring mixer embodiment of FIG. 17A.

In [FIG. 17]; FIG. 17A represents another arrangement of the mixing device incorporating the principals of the multi-element spring and multi-eccentric loads of the present invention, in which alternative embodiment of a combinatorial connection sub-stitutes directly for the hinge shown in [FIG. 6]; FIGS. 17B to 17E show various views of a generated multi-element spring and beam arrangement produced by an Artificial Intelligence (AI) powered Generative Design module of a Computer Aided Design (CAD) package.

FIG. 18 is a rendered representation of an AI CAD tool-generated model of FIGS. 17B to 17E.

### DESCRIPTION OF EMBODIMENTS

Referring to FIGS. 1A and 1B which show different perspective views of a mixing device 100 according to a preferred embodiment of the present invention and referring to FIGS. 2 and 3 which show and reflect typical but approximate dimensionality for various components (and thus typical dimensional ratios) for an established working example of the mixing device embodying the concepts of the invention.

The mixing device 100 is based around the flexing interaction of multiple (at least two and typically three) beams 102-104 and 102-106 respectively, in different planes of motion relative to a fixed anchor point 108, such as a heavy stable block or other bracing structure. Such flexing, which results in relative displacement between beams as well as twisting distortion in a plane of one or more beams, is initially produced by controlled rotation of a rotor 110 of a motor 112 that is securely fixed, via a clamp 114 or the like, at or towards a first end 116 of a first beam 102 (also termed the “backbone 102” or “principal beam 102”). The rotor 110 supports, i.e., carries an eccentric load 118. The interconnected beams 102-106, therefore, realise a multi-element spring.

The backbone 102 can be considered to have a shape, such as a generally rectangular shape. although it can include edge cut-outs 122-124, typically radial in shape, along peripheral edges of the backbone 102 and, optionally, weight-saving and/or strength-reducing cut-outs 120 within its area. However, the shape is a design option, and the shape may be generally symmetrical or may have asymmetrical features. The edge cut-outs 122-124 define a point of connection of the backbone 102 to other flexible beams, namely (1) at least a laterally extending lateral beam (or reference beam) 104 that projects outwardly from or near a lower or bottom edge of the backbone, and (2) and an optional but generally preferably present support beam 106 that also extends generally outwardly and away from the backbone 102, which extends from a second end 134 of the backbone 102 and which has a different orientation (i.e., it is inclined if not tangential) to that of the lateral beam 104. The first and second ends of the backbone, therefore, define a length of the backbone 102 between the proximal and remote ends thereof.

The point of connection between the backbone 102 and the respective lateral beam 104 and support beam 106 is through a respective substantially rigid hinge 126-128. For reasons of clarification, “substantially rigid” means that the hinge is generally stable although flexing or twisting can be induced in or along the length of the hinge when sufficient forces are introduced into the elements that make up the multi-element spring. The respective substantially rigid hinges 126-128 permit flexion movement of their respective beams relative to the backbone 102.

The support beam 106 permits the secure mounting of a container, such as a vial 130, to the support beam 106 through a suitable clamp 132. Mounting is generally central along the support beam 106, but a precise position is a design option. The reason why the support beam is an option is that the vial 130 could, in one embodiment, simply be fixed to the second end 134, via a suitable clamp or end loop, although such a fixing reduces the overall movement of the vial 130, provides no physical support of the vial 132 but reduces overall mass and complexity of the mixing device 100. The support beam 106 is, in the exemplary embodiment of FIGS. 1A and 1B and 2, are shown to be generally square in shape but other shapes are possible, including those with corner cut-outs that may, for example, define the hinged connection to a part of the backbone 102.

The lateral beam 104 may extend substantially tangentially from a plane of the backbone 102, but alternatively, the lateral beam may be angularly inclined (and not solely or ostensibly at right angles to the backbone 102). To introduce flexing and movement into and of the backbone 102 and lateral beam 104, the lateral beam 104 may be realized as a variable length beam in which bending forces across a width of the beam vary. The lateral beam 104 may, therefore, as shown particularly well in FIG. 1B, be realized as a generally rectangular plate that is fixedly attached, such as with di-agonally displaced screws or the functional equivalent, to an underlying triangularly shaped anchor point 108 or other suitably shaped stable anchors. For example, the area of contact between the bracing structure and the lateral beam 104 can be triangular where the two sides of the triangle are two sides of the lateral beam, and the hy-potenuse of the triangle bisects the lateral beam from one corner to another. This is shown by the varying length arrows L. L′ to L″ of the lateral beam 104 of [FIG. 2]. The amount of flexing movement in the lateral beam 104 thus increases across the width of the beam as a consequence of the geometry and its interconnection to the anchor point 107. As such, the lateral beam [or any functionally equivalent structure, such as an arc) is arranged to permit, when in use and further connected to a stable bracing structure, differing amounts of flexion movement along the substantially rigid hinge that connects the lateral beam 104 to the backbone 102. The bracing structure, supporting the anchor point, may be a stand or base for the mixing device. Flexing of the lateral beam can be achieved by having an area of contact between the bracing structure that is smaller than the third beam. The area of contact can be shaped to modify the degree and orientation of flexion.

The lateral beam 104 of FIGS. 1A, 1B and 2 is thus a variable length beam, and under varyingly applied directional forces supports movement of the multi-element spring/mixer in different planes of motion relative to other structure features (such as the support beam) of the multi-element spring. And all bending forces within the multi-element spring are relative to the motional stability of the bracing structure/anchor point 108.

Although not shown although previously implied (in FIGS. 1A and 1B), for a sterile system a diluent may be loaded into a syringe and then introduced into the interior of the [glass] vial 130 by having the syringe's needle puncture a self-sealing butyl membrane 150 set within a foil cap 152 (of FIG. 1B).

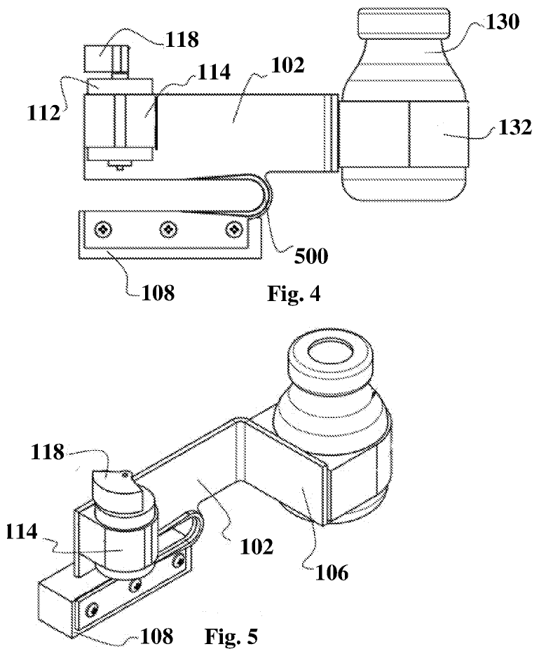

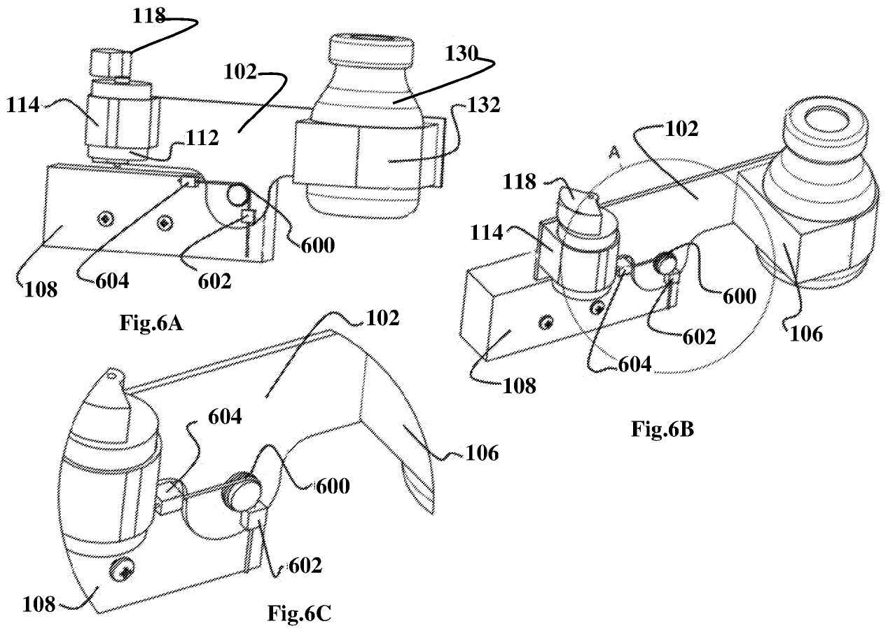

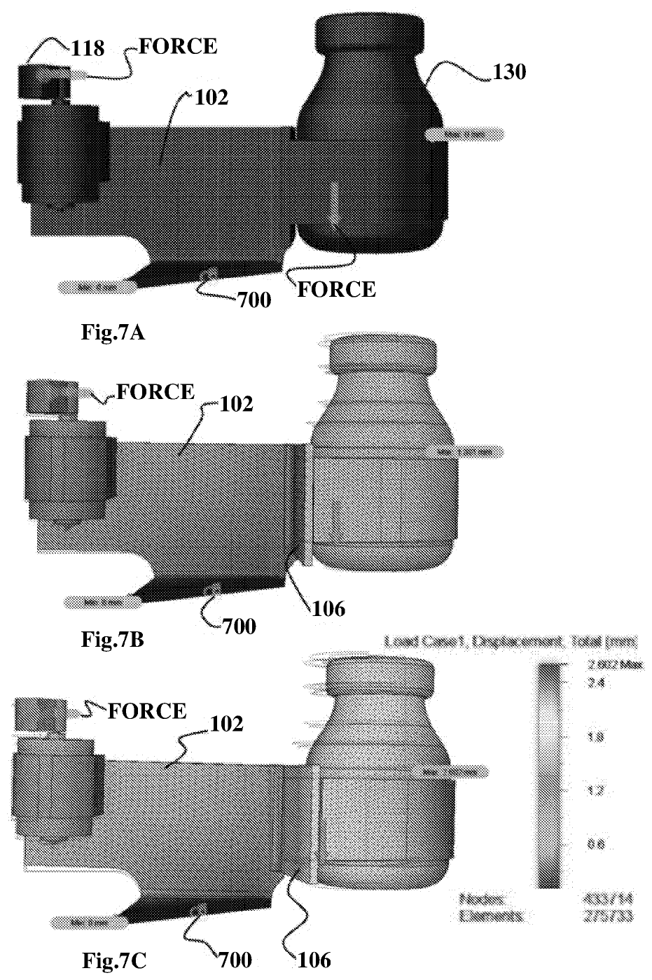

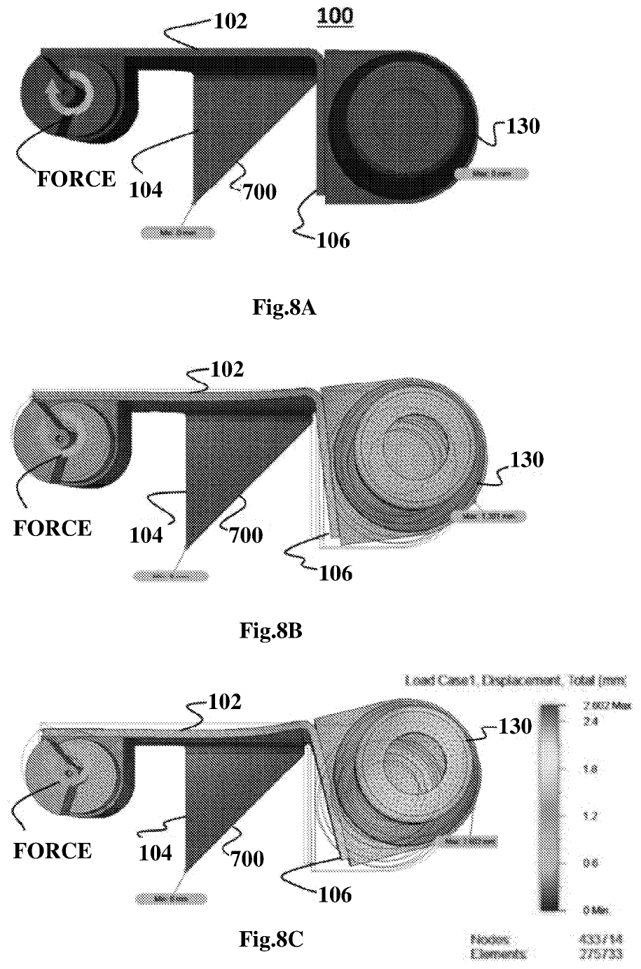

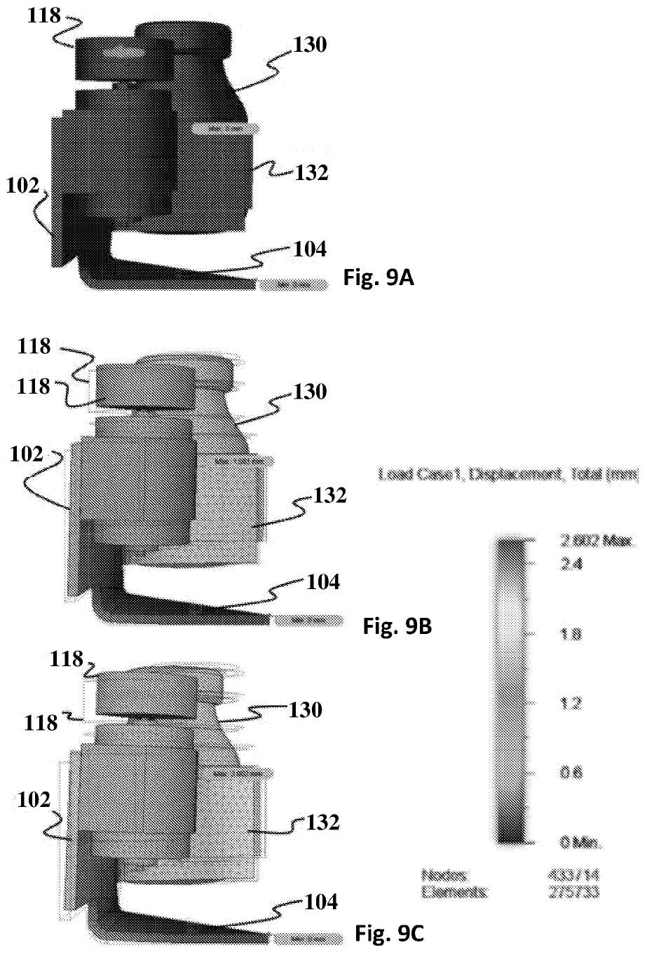

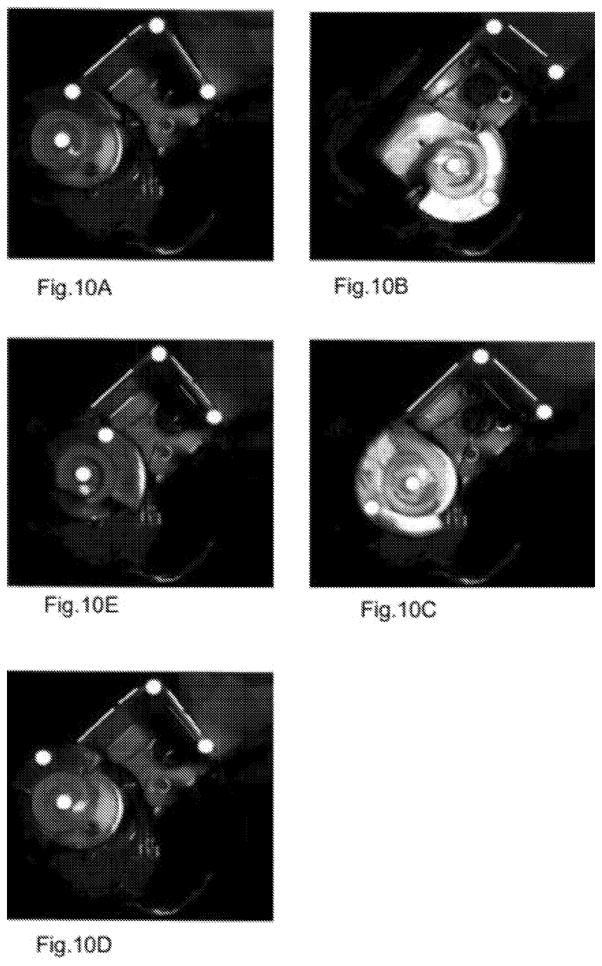

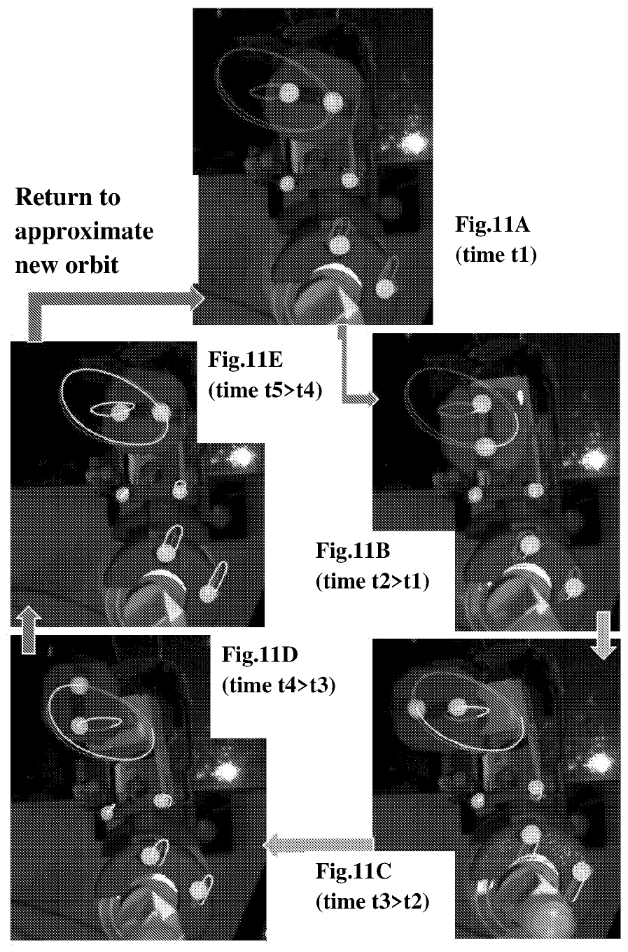

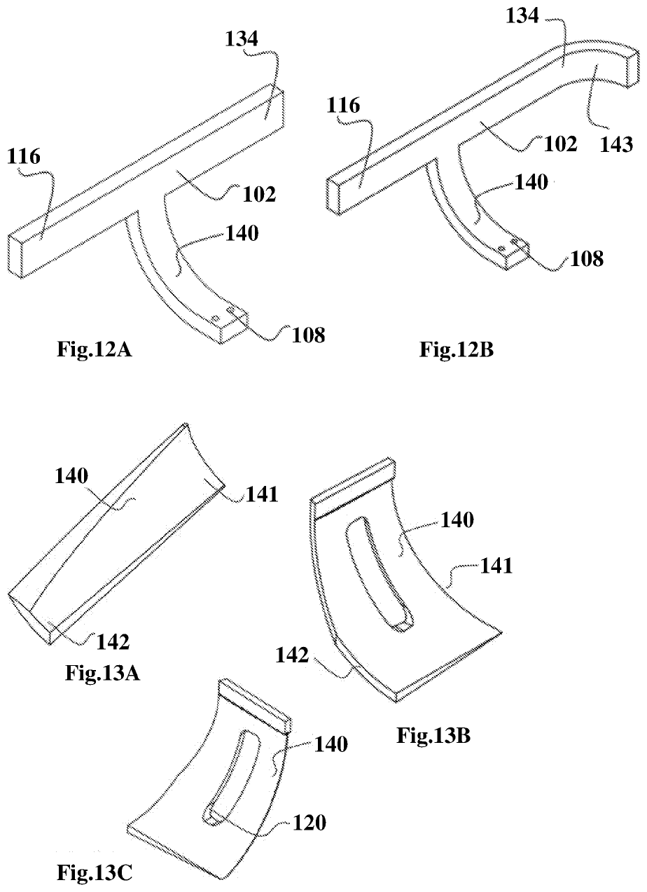

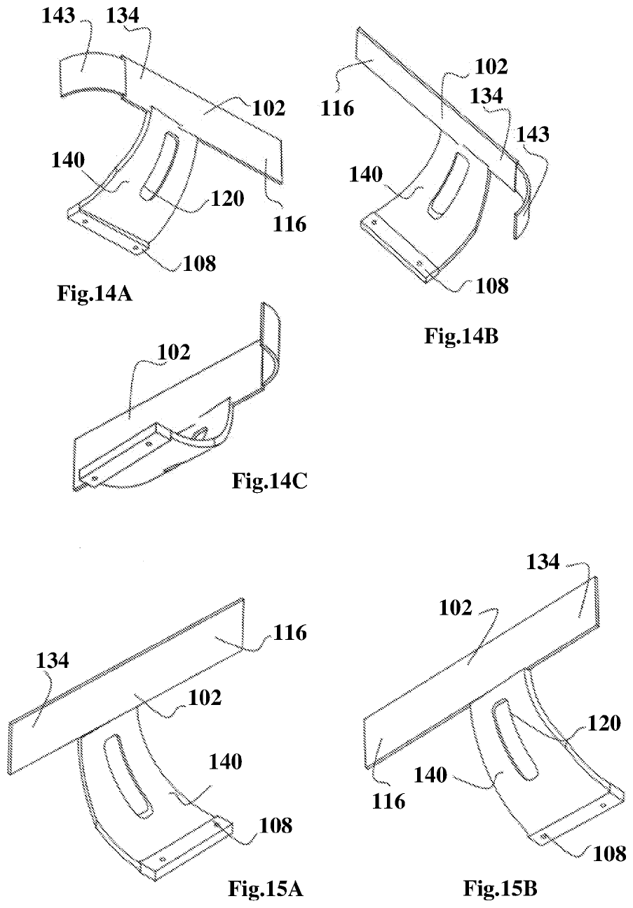

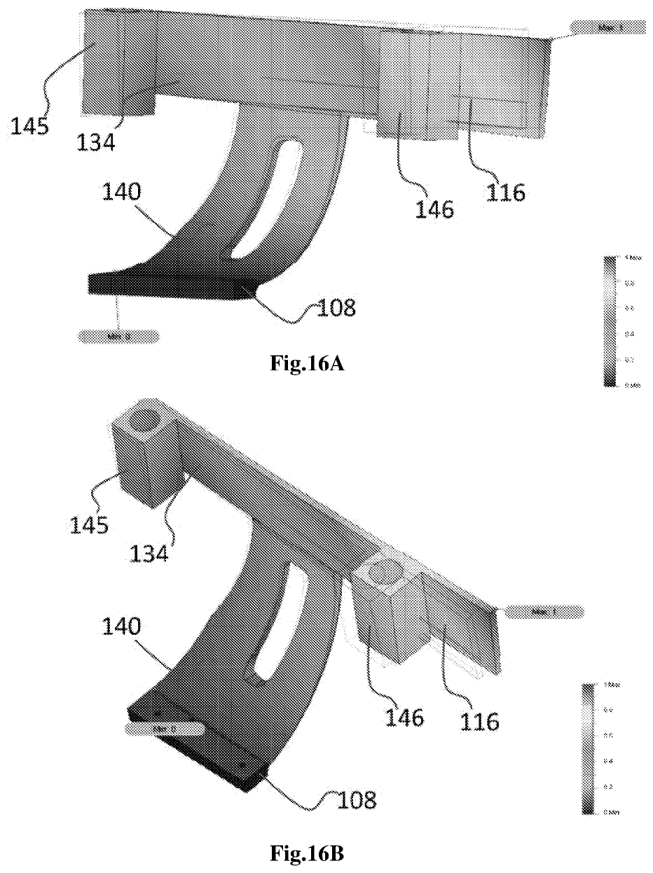

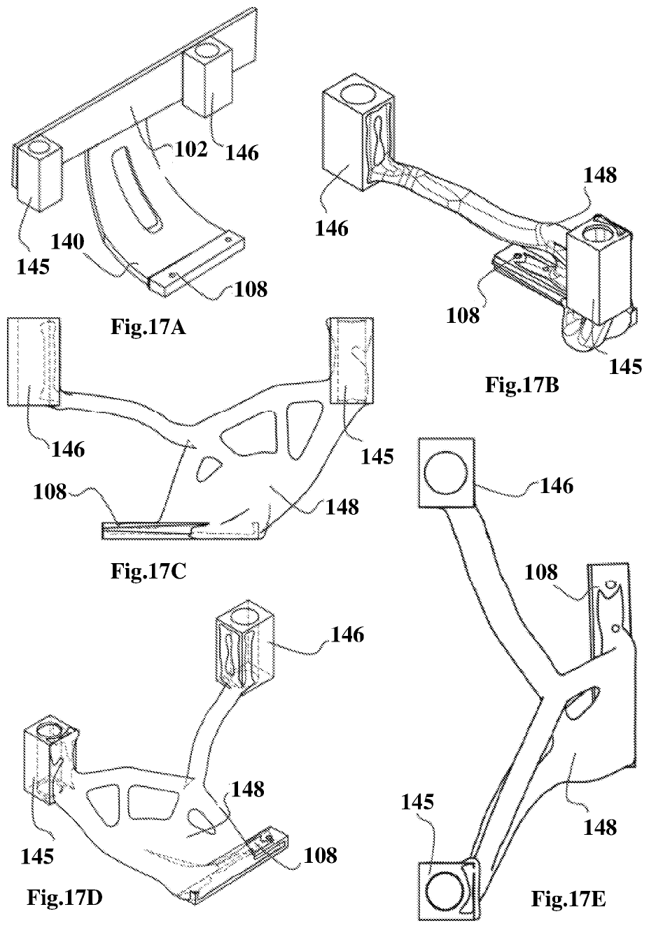

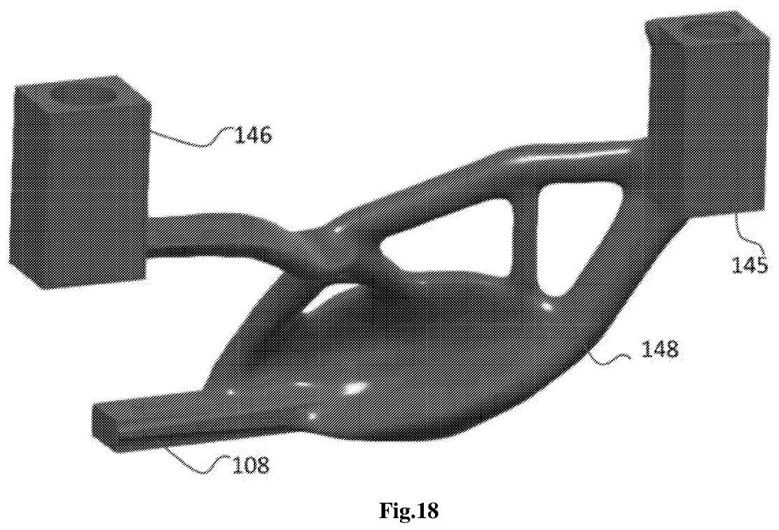

The lateral beam of the embodiment of, for example, FIGS. 1A, 1B and 2 may be realised by alternative structures such as a simple spring 500 or a torsion spring configuration 600-604, as respectively shown in the alternative mixer embodiments of FIGS. 4 and 5 (simple spring) and FIGS. 6A, 6B and 6C (torsion spring). Functionally, however, these alternative embodiments function in the same fashion as that FIGS. 1A and 1B since the backbone 102 and support beam 106 both still undergo flexing and/or plane or angular displacement under applied directional forces. In fact, as will be described later in relation particularly (but not exclusively) to FIGS. 12A and 12B, the simple spring 500 can be considered as a “combinatorial connection.” The physical shape of the stable anchor or bracing point 108 may, however, change given evident connection requirements of the respective simple spring or torsion spring arrangements. The simple spring or torsion spring therefore each provide further motion in the multi-element spring of the mixer, with these movement ability exploited by the arrangement and operation of the eccentric loads from (i) a generated active force from the motor's eccentric load and (ii) a reactive but reinforcing force component arising from consequential agitation and swirling of liquid and/or solid compounds/ingredient in the vial.

With respect to operation of the motor, this is subject to control by a motor controller 160 (referenced in FIG. 1A). For a typical medicament mixer, the typical masses for the eccentric load will be in the region of about 30 grams (g) to 40g. The motor will typically have a body height of about 30 millimetres (mm), and a diameter of 25 mm. Although rotational speeds will and indeed are preferably varied during the course of mixing to provide the system with a kick that encourages vortex formation in the contents of the vial, in the example of FIGS. 1A and 1B (for the exemplary preparation of Tazocin®), rotational speeds are selected to be in the exemplary but typical range of 1 revolution per see (1 r/sec) to approximately 14 r/s. Whilst not wishing to be bound by theory, this rotation speed depends on the desired fluidic motion, and for other preparations, it is also dependent on the load, scale and overall configuration of the multi-element spring of the mixer.

A typical vial mass is a region of about 90 g to 100g, including an allowance for 20 ml of water and 4.5 g of powdered medicament. A vial's nominal diameter is 46 mm and its height is 73 mm (for a 50 ml Type II glass vial with butyl rubber stopper and aluminium/plastic seal). Vial mixing volumes for medicaments are therefore in the typical range of a few millilitres to a few tens of millilitres. As will be understood by the skilled addressee, scaling to larger volumes requires adequate reinforcement of plane intersections to address the increased force arising from the increased mass in the ingredients that are being mixed.

Construction of the multi-element spring of the mixer 100 is preferably unitary, such as a molding. Suitable materials for the multi-element spring include rigid plastics. A plastic which is suited is polyoxymethylene “POM” (Acetal), other rigid plastics may also be used. Acetal is a common engineering plastic best known for its strength, rigidity, and ability to hold up against a variety of harsh conditions. Other suitable materials, as will be appreciated, including metals, metal alloys, carbon or glass fibre composites or hybrid material constructions which exhibit ‘spring’ characteristics. These include beryllium-copper alloy, titanium alloys, spring steel and titanium.

The material and geometries of the multi-element spring, including the substantially rigid hinges, thus provide a stiff and flexible structure that resists deformation and is sufficiently robust to permit repeated flexing in multiple planes when placed under varying directional forces. As will be readily appreciated, stiffness relates to how a component bends under load while still returning to its original shape once the load is removed. Applied forces can therefore bend, induce strain and to a degree stretch each of the components of the multi-element spring of the mixer of the present invention.

In overview, one or more substantially rigid hinges interconnect the backbone 102 respectively to one or more other beams to produce the multi-element spring system. A load, such as a vial or other container containing a mixture of diluent and compound, is located remotely from the motor. The multi-element spring system thus supports two independent but complementary eccentric load-generating subsystems arising from, respectively, the controlled rotation of the rotor (and its eccentric load) and then, in response to rotation of the connected eccentric load on the rotor, swirling of the diluent in the vial/container. The effect of the motor eccentric load can be varied by changing at least one of the eccentric mass' position relative to the motor and changing its mass. Both these eccentric loads contribute to a complex multi-directional flexing of the multi-element spring system [relative to a fixed anchor point 108], with this multi-directional flexing works to induce a vortex, i.e., a desirable fluidic motion that enhances mixing, within the contents of the vial. The nature of the mixing is highly complex and does not result in a simple vortex such as might be seen when using a vortex mixer, for example. Indeed, the relative movements of the interconnected beams 102-106, via the substantially rigid hinges 126-128, is highly complex.

It is understood that the multi-element spring arrangement is under a small, biased preload as a result of the positioning of the attached motor (including the driven eccentric mass) and the vial (with enclosed contents). More explicitly, once the mixer is loaded with a vial, the equilibrium state biases the complex spring system such that the system's centre of gravity causes some minor twisting of the backbone 102 along the two substantially rigid hinges 126-128. The motor and vial, under stable conditions, consequently, may be both slightly bent forward and dip to the side, i.e., there is a small angular inclination in both the backbone 102 and the outward extending lateral beam 104 relative respectively to a vertical datum [defined relative to the backbone] and a horizontal datum [defined relative to the outward extension of the lateral beam 104]. The effect is that, during motor actuation and active mixing, a random washing motion is initially produced within the contents of the vial since the contents of the vial overcome an additional gravitational force as the angles of inclination of the various sprung beams are flexed backwards and upwards relative to the vertical and horizontal datums. Eventually, operation of the system results in the system reaching a resonant state where movements in each of the multiple sprung beams of the system become less extreme, but at this point mixing is well underway and a vortex in the contents either formed or close to being formed.

In terms of functional operation of the mixing device of the present invention, the eccentric load 118 on the rotor 110 of the motor 112 is controllably rotated (normally clockwise) to induce forces into the rigidly restrained multi-element spring (relative to the bracing point 108). This causes a motion of the vial and its contents. As the velocity of the eccentric load is programmatically changed (normally increased), the sum of the active and reactive forces (respectively from the moving masses of the motor assembly and vial assembly) and the energy storage within the spring, an elliptical motion of the vial is created [noting that other patterns may be produced although these are observed to have been rarely circular in nature]. The elliptical motion is not normally symmetrical about the ellipse axis, and indeed motions at varying points within the multi-element spring are dissimilar (as shown in some of the accompanying drawings). Consequently, the diluent/solid matter in the vial is caused to move, e.g., rotate, swirl, vibrate shake and/or undergo a generally chaotic washing motion. Once the contents in the vial begin to move and swirl, they produce a secondary eccentric load that changes the magnitude of flexing within the multi-element spring of the mixing device 100. In a preferred secondary phase, to cause the vial contents to reach a resonant state and to induce a vortex or high-speed swirling of the vial contents to occur, the rotational speed of the rotor is modified, thereby adapting controllable input forces to bring about enhanced and different flexing or different cycles of flexing within the multi-element spring.

The controller (reference numeral 180 of FIG. 1A) is preferably arranged to operate in accordance with a program having at least two differentiated phases, namely (i) an initial phase that is followed by a transition into a so-called “kick-phase” in which an energy profile delivered by parameter control of the rotating actuator is changed significantly relative to that in the initial phase. The initial phase thus induces a swirling motion in the assembled container contents in the attached mixing container and the kick phase generally produces a vortex in the assembled container contents. The controller 180 is thus arranged to change and control rotational speed of the rotating actuator, i.e., the rotor and eccentric load, to generate varying rates of swirling. Moreover, the controller 180 is arranged to instantiate an initial phase that induces a motion by shaking the assembled container contents in the attached mixing container/vial 130, and then at least a secondary phase that induces swirling motion in the assembled container contents as the system approaches and achieves resonance. Movement of the assembled contents in the vial 130 represents a secondary eccentric load that induces additional flexion movement through generation of dynamic bending forces within the multi-element spring arising from time-varying loads operating at the proximal end and distal end of the backbone (or principal) beam 102.

Selected parameter control of motor operation can relate to at least one of: control of the duty cycle in a pulse width modulated signal controlling rotation of the rotor 110 and related eccentric load 118; and voltage delivered to the motor 112 to affect a change in current through the motor.

Motion at a top of the vial, following the kick phase, generally follows an elliptical path. Production of the vortex is caused by the controller establishing a relatively predictive moving state as the system {comprised of the mixing container, multi-element spring and rotating actuator] collectively approaches system resonance.

The controller is preferably arranged to operate to control energy delivery that includes at least one of: a linear variation in delivered energy; a variation in delivered energy; and a non-linear variation in delivered energy. Controlled delivery of energy to the system is maintained until full mixing or dissolution of contents within the vial 130 or other mixing container is attained.

The practical upshot of the new mixer design of the various embodiments is that, in the entirely exemplary case of preparation of an eye clear state for the drug Tazocin®, reconstitution is achieved in about ninety seconds. This contrasts with the twelve or so minutes required under current standard manual mixing practices. Of course, other drugs and mixtures, including but not limited to body-building drink supplements and varnishes, can be more effectively reconstituted or made using the new mixing device.

Referring to FIGS. 7A to 7C, 8A to 8C and 9A to 9C, these figures show an approximation of movement of the various components and beams and hinges of respectively the mixer system and the multi-element spring. The images are presented using finite element analysis “FEA” relative to a “locked position” at the interface of the lateral beam 104 and bracing point(s) on the support structure. Although modelled from the sole perspective of a ninety-degree) (90° revolution of the eccentric mass 118 on the motor (and not from the additional perspective of the secondary eccentric load from the vial), the FEA shows a succession (especially noticeably in relation to the “B” and “C” parts of FIGS. 7 to 9) of overlaid relative displacements of the beams 102-106, hinges 126-128 and vial 130. Overlaid line images and variation in shading and intensity levels both reflect displacement. It is noted, however, that the FEA representations are only indicative of motions and bending potential within the system of the invention. FIGS. 7 to 9 are thus neither qualitative nor quantitative since the FEA representations are dependent on the parameters used and, in this case, should be treated as a primitive first approximation in movement not least because, as will be appreciated, FEA modelling on multiple separate eccentric load conditions is highly complex.

The FEA of FIGS. 7A to 9C does, however, reinforce the nature of the motions in the mixer of the invention, with FIGS. 10A to 10E showing the in-cycle operation of the mixing device in a succession of photographic images captured using a high-speed, five hundred frames per second camera. In FIGS. 10A to 10E, a central white circular dot has been introduced to mark both the rotor position and also the centre of the eccentric load 118 on the rotor 110. Both the rotor position and the centre position of the eccentric mass are shown to change from an in-cycle, under load, rotating operational point for the eccentric mass at approximately 12 o'clock, through its later positions at approximately 1 o'clock, 5 o'clock, 7 o'clock and 11 o'clock. Additionally, circular markers at a remote tip of the support beam 106 and above the substantially rigid hinge that connects the backbone 102 to the support beam 106, as well as line markers for top and bottom edges of the backbone 102 and support beam 106 show, as a consequence of relative movement between these line markers, distortion in the planes of those beams as well as twisting and general displacement of the components of the multi-element spring in multiple planes of motion.

FIGS. 11A to 11E show a succession of captured images on which developing orbital motions for tracking features on a mixing device, manufactured in accordance with the design of [FIG. 2], have been mapped by tracking software. The time-lapsed in-cycle images establish the complex flexing and movement of datums within the overall mixer, including: i) the centre rotor 110; ii) the middle point on the eccentric mass 118 on the rotor; iii) an upper point above the substantially rigid hinge that connects the backbone 102 to the support beam 106; iv) the remote tip of the support beam 106; v) a centre point in a clamp member holding the vial 130 securely to the support beam; and vi) an edge region of the clamp member that is displaced radially from the immediately aforementioned centre point in the vial's clamp member.

The information that can be derived from the succession of tracked orbits in FIGS. 11A to 11E is that:
i) there are changes in both the relative displacement and orbital motions for each point, including that some orbits are generally elliptical, some somewhat circular, some somewhat linear and the majority of successive orbits offset in space over time. In the latter respect, the relative intensity of the tracking reflects orbital development;
ii) there are relative changes in relative position between different marked points;
iii) developing orbits for near-neighbouring points may be in different orientations, i.e., a first orbit for the centre of the rotor is anti-clockwise whereas the orbit for the middle point on the eccentric mass 118 develops in a clockwise fashion; and
iv) successive orbits may be different in that they have one or more cross-over point(s). The system is not in exactly harmonious operation.

FIGS. 11A to 11E thus confirm that the complex flexing nature between interacting aspects of the multi-element spring of the mixing device of the invention and reflects those differential directional forces of different magnitudes that arise within the mixer to produce effective mixing (of a medicament, varnish, paint, soluble food preparation or whatever).

FIGS. 12A and 12B show a primitive representation of a mixing device according to two alternative structural arrangements that are equivalent in function to, respectively, a two-beam arrangement of [FIG. 6] and a three-beam mixer arrangement of FIGS. 1A and 1B.

FIG. 12A shows the principal beam 102 having a distal end 134 and a proximal end 116, connected to a functional equivalent first combinatorial connection 140, and further connected to the stable anchor or bracing point 108. The first combinatorial connection 140, replacing the reference beam 104 and the substantially rigid hinge 128 of (for example) FIG. 1A, has an integrally formed curved element that attaches to the principal beam 102 and extends downwards and out of the plane of the principal beam. The curved element is shown centrally located but the precise location along the length of the principal beam is design dependent and determined by stiffness, spring and/or total load requirements. The first combinatorial connection 140 is arranged to permit, in use, a change in relative orientation between the beam 102 and the stable anchor or bracing point 108, said change generally equivalent to that permitted by the substantially rigid hinge and to also permit a change in stiffness or flexibility relative to hinge axis of combinatorial connection 140 in use.

FIG. 12B shows the multi-element spring of FIG. 12A with the addition of a second combinatorial connection 143 joined to the distal end 134 of beam 102 and extending at an angle (between and acute angle to an obtuse angle) relative to the plane of the principal beam 102. The second combinatorial connection 143 replacing the substantially rigid hinge 126 and beam 106 of, for example, FIG. 1A. The second combinatorial connection 143 is arranged to permit, in use, a change in relative orientation and/or position between at least the distal end 134 of the beam 102 and distal end of the second combinatorial connection 143, said change generally equivalent to that permitted by the substantially rigid hinge 128 and to also permit a change in stiffness or flexibility relative to hinge axis of combinatorial connection 143 in use. The second combinatorial connection 143 can again be realised to include a curve.

[As an aside, it will be readily appreciated by the skilled addressee, and thus for clarifying purposes only, a hinge axis is a straight line about which a body or geometric object rotates or may be conceived to rotate.]

In response to variations in loads and resultant torsion forces experienced by the combinatorial connections 142 and 143 shown in (for example) FIGS. 12A and 12B, the uneven bending moment about the hinge axis as well as the thickness variations and/or shape variations of the combinatorial connections 142 and 143 cause, in use, a change in relative position and orientation of their respective hinge axes.

The FEA of FIGS. 16A and 16B and FIGS. 13A to 15B generally show how such a combinatorial connection 140, having a variable thickness 141, 142, enable relative motion under time-varying load broadly comparable with the combination of reference beam 104 and substantially rigid hinge 128 of at least [FIG. 1] and [FIG. 2] and FIGS. 7A to 9C.

Unless specific arrangements are mutually exclusive from one another, the various embodiments described herein can be combined to enhance system functionality and/or to produce complementary functions or systems that support the effective identification of user-perceivable similarities and dissimilarities. Such combinations will be readily appreciated by the skilled addressee given the totality of the foregoing description. Likewise, aspects of the preferred embodiments may be implemented in standalone arrangements where more limited functional arrangements are appropriate. Indeed, it will be understood that unless features in the particular preferred embodiments are expressly identified as incompatible with one another or the surrounding context implies that they are mutually exclusive and not readily combinable in a complementary and/or supportive sense, the totality of this disclosure contemplates and envisions that specific features of those complementary embodiments can be se-lectively combined to provide one or more comprehensive, but slightly different, technical solutions that each realise cyclonic mixing with the mixing container (whether the mixing container is sealed or not). In terms of any suggested process flows related to the operation of the designs shown in the accompanying exemplary drawings, it may be that these can be varied in terms of the precise points of execution for steps within the process so long as the overall effect or re-ordering achieves the same objective results or important intermediate results that allow advancement to the next logical step. The flow processes are therefore logical rather than absolute.

Supporting aspects of the various embodiments of the invention may be provided in a downloadable form or otherwise on a computer-readable medium, such as a CD ROM, which contains program code that, when instantiated, executes the link embedding functionality at a web server or the like. For example, specific mixing control algorithms for specific compounds may be selected from a local library or downloaded. Such control algorithms may define discrete timing transitions between mixing phases, including changes that affect rotational speeds of the eccentric weight to affect energy profiles for energy delivered into the system.

It is appreciated that the above descriptions have been given by way of example only and that modifications in detail may be made within the scope of the present invention. For example, geometries in connecting structures between abutting mixing planes can include edge cut-outs having curved profiles that reduce the physical size of the material through which forces pass from one component to the next. Additionally, the various beams can include cut-outs to reduce overall weight. Dimensionality, such as overall lengths of the beams, the length of the substantially rigid hinges, the nature of the material in terms of composition (plastic, such as polypropylene, or metals) and uniform of varying thickness can be adjusted to tune the resultant system to a particular application. Indeed, compensatory changes between interacting components of the multi-element spring allow, as will be understood, dimensions of one component to be altered, i.e., offset, at the expense of dimensions in another component whilst still achieving the same mixing effect. In other words, ratios of component dimensionality may change, and relative angular displacement can thus be affected whilst the resultant multi-element spring still achieves desirable vortex generation.

Tuning of the system may, for example, be achieved either by controlled energy delivery by the motor and/or by altering the mass or position of the mass of the eccentric mass on the rotor and/or the position of the mixing container. In other words, the eccentric load on the rotating actuator may be a variable eccentric load.

However, refined tuning of the physical parameter that affects specific flexing of the various beams and hinges [that realise the multi-element spring of the mixer] to optimise the mixer for a particular application can lead to a de-tuned mixer for different applications, e.g., different medicaments. In this respect, mixing performance may be tuned based on a generic physical structure and then honed for a specific application through selection of (i) active control of rotational speeds of the motor and/or (ii) selected mass of the eccentric mass on the motor, and/or (iii) mass and/or position of the vial/container, and/or (iv) selected position of the eccentric weight fixed to the shaft of the motor. As will be appreciated, energy developed by rotational velocities and rotational forces can be used to affect flexing of the various sprung beams.

The dimensionality of the principal dimensions for the various beams and related hinges (as well as positioning of one or more of the eccentric load and vial/container) are therefore exemplary. The dimensions shown in the table of [FIG. 3] represent a tuned system particularly suitable for the preparation and mixing of mixing Tazocin® (a notoriously difficult composition to mix to a water-clear state). Variations in dimensionality, such as lengths and thicknesses of the backbone 102, radii for cut-out 124 and weight and position of eccentric load 118, thus are not limiting so long as the principles in the bi-loading of the multi-element, multi-spring system with eccentric generators, as described herein, are observed. Indeed, the thicknesses of the various features and the materials selected for the manufacture of the various components of the mixer device are to a degree dependent on the loads and physical scale of the mixing device. The skilled addressee will therefore appreciate this statement and observe the dimensions in the table of [FIG. 3] may be varied and, indeed, that flexibility and thus relative movement in one component may be deliberately offset against flexibility in another interacting component.

The important aspects remain consistent regardless, namely that there are multiple degrees of freedom of movement inducible in the pre-loaded multi-element spring system of the mixer, and the spring system supports two independent but complementary eccentric load generating subsystems, namely the eccentrically loaded motor and the relatively remotely located contents in the vial/container.

In the latter respect, whilst not wishing to be bound by theory, it is understood that eccentricity induced by the vial/container and its load is brought into the system by (i) a relative change in the centre of gravity of the vial/container and its contents with respect to the overall multi-element spring mixer, and/or (ii) the forces required to overcome the action of gravity that otherwise resists the movement of the contents backwards [in the direction of the backbone] relative to a stationary steady-state position for the contents.

Furthermore, whilst the foregoing description has concentrated on the exemplary mixing of a medicament in a sterile vial and particularly (but not exclusively) on a mixing solution for Tazocin®, the structural concepts of the multi-spring element mixer can be applied to mix or produce a cream or emulsion. In the mixing of emulsions, the limiting factor will be the viscosity of the emulsion. The present invention is, in fact, able to mix any combinations of liquid and solid, dissimilar liquids and combinations of multiple solids/liquids.

In fact, rather than being generally planar, one or more of the beams can themselves be formed from, or to include, curve surfaces [and thus be bowed] that can be continuous with the radii [equivalent to the aforesaid substantially rigid hinge] that realise a significant change in orientation of and between any active beam element (irrespective of whether each or any of the active elements is generally flat or curved). The radii can be constant or variable. Whilst not wishing to be bound by theory, the use of curved surfaces may reduce localised stresses at the points of orientation change whilst preserving the multi-dimensional movements and multiple axes of motion in the mixer device. Formation of this alternative but functionally equivalent structure can be achieved by an injection molding process, 3-D printing or by appropriate bending of a shaped metal or composite plate. The elements of the radii may, also, be optionally se-lectively thickened/thinned or reinforced across a connecting length of the complementary active elements in the structure, although such thickening/thinning/reinforcement comes as a trade-off against flexibility/flexion properties and resultant movement within and between the active elements of the mixing device.

As described herein and as will now be appreciated from the FEA analysis, the purpose of the “substantially rigid hinge” is to support a flexing connection between two structural elements (e.g., the previously described beams) and to permit movement, about the axis of the hinge, of those at least two structural elements. It will therefore be appreciated the substantially rigid hinge may be realized in many alternative forms, including, but not limited to, (a) a simple bend (in the form of a radius bend or variable radii bend) along which the hinge axis or axes are realized (as shown in FIGS. 1A and 1B), (b) the curved beam arrangement in FIGS. 4 and 5, (c) the alternative spring and pin hinge of [FIG. 6] and (d) the combinatorial connections in FIGS. 13B to 17A.

Whilst some of the preferred embodiments describe the use of two or three beams that are substantially perpendicular to one another and in which the respective beams are joined by a “substantially rigid hinge”, the invention is not so limited. Any equivalent functional arrangement, such as those provided by curved geometries and in which at least one of the substantially rigid hinges is a radius (such as shown in FIGS. 13A to 13C) can be readily substituted.

The FEA results shown in FIGS. 16A and 16B demonstrate that the structures of the various mixer arrangements of the different embodiments of the invention have functional similar responses to time-varying forces. It is noted that, in FIGS. 15 and 17, eccentric forces introduced by separated loads are shown only as representation blocks (reference numerals 145 and 146).

While several alternative and complementary arrangements are described herein to realise the multi-element spring of the mixer 100, the functional equivalent(s) of at least the beam 102 connected by the substantially rigid hinge 128 to the beam 104, and a stable anchor point 108, are required. Dimensions and arrangement of the functionally equivalent component(s) are at least dependent on the nature of the two eccentric loads, their positions relative to each other and to the beam 102, and to the position of and behaviour of the connecting substantially rigid hinge 128 or equivalent combinatorial connection (in FIGS. 15A to 17A).

It will be appreciated that with the use of advanced structural and material property modelling design tools, a functional equivalent structure of interconnected flexible elements in an interconnected lattice structure may be realised as a single part or a limited number of connectable parts. Such lattices, as shown in FIGS. 17B to 17D, are functionally equivalent to the principal beam 102, the reference beam 104 and the second substantially rigid hinge 128. Indeed, by analysing the movement trajectory examples pictorially described herein (FIGS. 7A to 11E), a functional equivalent to the disclosed multi-element spring of mixer 100 may be realised with the aid of the aforementioned advanced structural and material property modelling design tools. The intermediate lattice of FIGS. 17B to 17D shows, a purely exemplary reversed engineered form generated by a generative design tool programmed with a requirements speci-fication based on FIG. 17A. These are simply manufacturing issues relating to the preferred approach in physical realization of the mixer of the invention.

The mixer beams and hinge(s) arrangement may be realised using traditional manufacturing and assembly processes or may be realised, at least in part, by additive manufacturing processes. The options for combining structural elements and the required hinges are numerous and various alternative layouts may be created using Artificial Intelligence powered design aids, such as Generative Design, many of which designs are made possible using 3D printing processes such as, for example, Selective Laser Sintering, Fused Deposition Modelling and Electron Beam Melting, of a selection of metals and plastic polymers including but not limited to metals, metal alloys and, polymers and fibre reinforced polymer material mixes.

Such 3D printable arrangements and associated additive manufacture methodologies potentially allow for the separation of a single structural element (or beam) or hinge into two or more complementary parts or a complex lattice structure or structures, arranged to be functionally equivalent to the beam(s) or hinge(s) respectively, or any combination thereof and further allow if desired, for the assembly of the beam or beams, and hinge or hinges into a single structure or a smaller number of connected discrete structures, arranged to be the functional equivalent of the conjoined or connected separate elements or features as shown in FIGS. 17B to 17E and further as shown in the example 148 of [FIG. 18].

Therefore, the functional design of the describe embodiments is not limiting so long as the principles in the separated eccentric bi-loading of a multi-element, multi-spring system that flexes in multiple geometric planes are observed.

Whilst the principal of the mixer have been described in detail above, an overall mixing system may include complementary monitoring and/or identification technology, such as a camera sub-system. The camera sub-system can be arranged to interpret container label detail from scanning of a code or reading a label, text or graphics. This can be used as a safety cross-check, for audit purposes or for pro-gramming of the mixer to follow a particular sequence of energy delivery.

The camera sub-system may also capture the position in time of moving features of the mixing device to identify potential fatigue in the device components and thereby either to permit modification of operational parameters to ensure consistent mixing results, and/or to generate a service/maintenance action.

Furthermore, the mixing device of any of the embodiments may be optionally enabled with position, proximity and single or multi-axis motion sensors to capture the position in time of moving features of the mixing device. Sensors may be sup-plementary or alternative to any optical camera-based sub-system.

The mixing device may also be connected to remote computers or computer networks, such as cloud-based services, and to operate as a connected device, i.e., as an Internet of Things (IoT) device configured to communicate bi-directionally with remote resources, thereby enabling monitoring and, if required, some degree of oversight control over the operating parameters of the mixing device.

The mixing device or a functional component thereof may be incorporated into a complex robotic system wherein a diluent may be robotically added to a mixing container and/or the mixture container may be robotically inserted into a clamp. There is not a preferred order for the aforementioned robotic steps of adding diluent or mixture container insertion into a clamp. As an example, a microprocessor-controlled robotic system with multiple mixing devices or functional components thereof, may be purposed to the mixing of multiple mixtures with a lesser degree of manual ma-nipulation required to achieve a desired outcome of multiple mixed medicines or multiple mixtures.

### CLAUSES

The following clauses represent equivalent structural alternatives of the mixing device and/or operational functional changes for various embodiments of the invention but remain consistent with and are contained within the totality of the above description.

Clause I. A mixing device comprising: a multi-element spring containing a plurality of conjoined beams each supporting multiple planes of motion, wherein at least one pair of the plurality of conjoined beams is coupled together by a substantially rigid hinge and said at least one pair comprises: a backbone beam having a first end arranged to hold securely a rotating actuator supporting a first eccentric load, and a second end remote to the first end, the second end including a clamp for securing, in use, a mixing container; and a reference beam conjoined to the backbone beam along a substantially rigid hinge, wherein the reference beam extends relatively outwardly from the backbone beam and the reference beam has variable stiffness longitudinally effective relative to the orientation of the backbone beam, an electro-mechanical actuator arranged to controllably cause rotation of the first eccentric load; a micro-processor-based controller exercising parameter control defining operation of the electro-mechanical actuator and instantaneous amounts of energy provided to the mixing device, wherein the multi-element spring is arranged to flex in multiple degrees of freedom in response to a combination of complementary forces arising from rotation of the first eccentric load and a secondary eccentric load held in the clamp, the secondary eccentric load substantially arising in response to rotation of the first eccentric load.

Clause II. The mixing device of any of the preceding Clauses, wherein the reference beam is inclined relative to the backbone beam by angle in the range of about five degrees to ninety degrees.

Clause III. The mixing device of any of the preceding Clauses, wherein the angle is dependent upon the variable stiffness of the reference beam.

Clause IV. A mixing device comprising: a rotating actuator carrying an eccentric load; a microprocessor-based controller exercising parameter control of the rotating actuator to control energy provided, at least in part, into the mixing device through controlled rotation of the eccentric load; a mount configured to hold the rotating actuator; a clamp configured to hold a mixing container representing a mass, when in use the mixing container includes at least one liquid as part of assembled container contents; a multi-element spring containing a plurality of conjoined beams each providing at least one degree of motion, the multi-element spring including a principal beam having a proximal end, a distal end and a bottom edge, wherein the mount and rotating actuator are securely coupled substantially at the proximal end of the principal beam; a second beam fixed, through a first substantially rigid hinge, to the distal end of the principal beam, wherein the second beam extends relatively outwardly from the principal beam and wherein the first substantially rigid hinge permits flexion movement of the second beam relative to the principal beam and the second beam further holds the clamp; a third beam fixed, through a second substantially rigid hinge, to a part of the bottom edge of the principal beam, the third beam extending relatively outwardly from the principal beam, and wherein: outward extension of the third beam increases from the second substantially rigid hinge across a width of the third beam; and the third beam is arranged to permit, when in use and further connected to a stable bracing structure, differing amounts of flexion movement along the second substantially rigid hinge.

Clause V. The mixing device of any of the preceding Clauses, wherein mixing performance is tuned based on at least one of: active control of rotational speeds of the rotating actuator; selected mass of the eccentric load on the rotating actuator; mass of the clamp; position of the clamp; mass of the mount; position of the mount; mass of the mixing container; position of the mixing container; mass of the compound contained within the mixing container; mass of the liquid contained within the mixing container; position of the rotating actuator; and mass of the rotating actuator.

Clause VI. The mixing device of any of the preceding Clauses, wherein mixing performance is tuned based on at least one of: active control of rotational speeds of the rotating actuator; selected mass of the eccentric load on the rotating actuator; mass of the clamp; position of the clamp; mass of the mount; position of the mount; mass of the mixing container; position of the mixing container; mass of the compound contained within the mixing container; mass of the liquid contained within the mixing container; position of the rotating actuator; and mass of the rotating actuator.

Clause VII. The mixing device of any of the preceding Clauses, wherein the controller is arranged to cause a change in rotational velocity in the assembled container contents through selected parameter control, said selected parameter control by the controller affecting speed of rotation of the eccentric load about the rotating actuator.

Clause VIII. The mixing device of any of the preceding Clauses, wherein the eccentric load of the rotating actuator is a variable eccentric load having at least one of: a selectable weight; a selectable shape of the eccentric load; a selectable position of the of the eccentric load; a selectable position of the of the eccentric load relative to an axis of the motor; a selectable shape of the eccentric load; a selectable material density of the eccentric load; and a selectable distribution of mass within the eccentric load.

Clauses IX. The mixing device of any of the preceding Clauses, wherein bending forces within the multi-element spring are relative to motional stability of the bracing structure.

Clause X. The mixing device of any of the preceding Clauses, wherein combined resultant forces within the mixing device arising from controlled operation thereof cause the mixing container to move in an approximately predictable cyclical trajectory.

Clause XI. The mixing device of any of the preceding Clauses, wherein, in use, combined resultant forces within the mixing device arising from controlled operation thereof cause the mixing container to move in a chaotic trajectory.

Clause XII. The mixing device of any of the preceding Clauses, wherein the material relief of varying geometry is at least one of: an edge cut-out; a hole; a channel; variable length; varying geometric shape; and variable thickness.

Clause XIII. The mixing device of any of the preceding Clauses, wherein the controller is arranged to instantiate an initial phase that induces a chaotic motion by shaking the assembled container contents in the attached mixing container, and then at least a secondary phase that induces swirling motion in the assembled container content.

Clause XIV. The mixing device of any of the preceding Clauses, wherein production of an approximation to a vortex is caused by the controller establishing a relatively predictive moving state as a system, containing the mixing container, multi-element spring and rotating actuator, collectively approaches system resonance.

Clause XV. The mixing device of any of the preceding Clauses, wherein mixing performance is tuned based on at least one of: active control of rotational speeds of the rotating actuator; selected mass of the eccentric load on the rotating actuator; position of eccentric load on the rotating actuator; mass of the mixing container; position of the mixing container; mass of the compound contained within the mixing container; mass of the liquid contained within the mixing container; and position of the rotating actuator.

Clause XVI. A method of dissolution or homogeneous mixing of a sterile compound or solid into a diluent or liquid introduced into a sterile container initially containing (a) the sterile compound or sterile solid and (b) gas, the method comprising generating multiple time-varying dynamic multi-directional flexing in individual elements of a multi-element spring of a mixer to induce a swirling motion of the diluent in the container, wherein the motion initially in the diluent is produced by selectable motor-driven rotation of a first eccentric load of the mixer at a proximate first end of a first element of the multi-element spring of the mixer whilst the container is securely fixed at or near a remote second end of the first element, and time-varying dynamic multi-directional flexing within the elements of the multi-element spring is relative to a substantially motionally-stable bracing point to which one element of the multi-element spring is securely fixed; and controllably causing a change in energy to be imparted into the multi-element spring by changing operational parameters of a motor driving said rotation of the first eccentric load to cause at least swirling to form within the diluent in the sterile container.

Clause XVII. The method of dissolution or homogeneous mixing of Clause XVI., wherein movement of the contents in the container represents a secondary eccentric load that induces compound flexing through generation of dynamic bending forces within elements of the multi-element spring, said compound flexing arising from differing positions for time-varying loads applied at the separated proximal end and distal end of the first element.

Clause XVIII. The method of dissolution or homogeneous mixing of Clause XVI or Clause XVII. further comprising causing a change in rotational velocity in the contents in the container through rotational speed of the first eccentric load.

Clause XIX. The method of Clauses IV-VII wherein one or more damping mechanisms are connected to the multi-element spring and realise tuning of at least one of; multi-element spring; or the mixing device.

### PATENT LITERATURE

WO 05/077511 essentially relates to a “wobble table” supported by four sprung legs.

DE 2941421 relates to a paint mixer in which a paint tin is held in place on an os-cillating plate by magnets. The up and down movement produced by this device does not suggest or indicate that it is capable of producing a mixing vortex.

U.S. Pat. No. 3,637,190 relates to an open, non-sterile system that deburs/polishes work pieces within a drum. This follows, for example, from col. 2, lines 18 to 24, namely “a chamber 35 . . . is adapted to receive . . . a media M of ceramic chips or other abrasive materials and a suspended batch of parts P which are to be surface finished such as by a deburring, polishing or descaling operation”. The fact that the system employs coil springs and spring beams to attain a resonant frequency of oscillation with changes in the load. U.S. Pat. No. 3,623,706 is related to U.S. Pat. No. 3,637,190.

U.S. Pat. No. 3,643,384 is again related to U.S. Pat. No. 3,637,190. The subject-matter of U.S. Pat. No. 3,643,384 describes a large trough for deburring large-scale items, such as aircraft wings (see col.1, lines 4 to 8). The trough is configured, with spring biasing, to be shaken/vibrated. GB 992002 is another deburring machine in the form of a trough-based vibrator, as can be seen from [FIG. 6] of that document.

DE 1913374 relates to a system for polishing and potentially cleaning rather than mixing. FIGS. 4 to 8 of DE 1913374 establish that the system is not a sealed via, but rather a lid-clamped system on a rotating table driven by a motor with an eccentric load (elements 7 and 9).

US 2006/093529 granted as U.S. Pat. No. 8,017,094 is a biological sample analyser that operates on the premise of shaking.

CN 112354438 relates to a sieving of flour, as shown in FIGS. 4 and 5 of that document.

CN 215877456 U describes; The utility model discloses a medicine dispensing device for hospital pharmacy. The medicine dispensing device comprises a medicine mixing driving mechanism, a medicine bottle positioning auxiliary mechanism, a device base, a left side supporting vertical plate, a right side supporting vertical plate, an auxiliary spring, a medicine mixing operation groove, an auxiliary medicine bottle frame, small medicine bottles and a medicine mixing auxiliary plate.

JP H0952039 describes; A PROBLEM TO BE SOLVED: To provide a vibrating device with only one motor and one vibrating body by disposing a vibrating body, an eccentric weight and a motor in a series and conform the hole of the center of gravity with the center of vibrating force of the eccentric weight. SOLUTION: A vibrating body 1, an eccentric weight 5 and a driving motor 8 are disposed in series. The axial line of the vibrating body 1 running through the center of gravity center of the vibrating body 1 and being in parallel with the axis of annular vibration of the vibrating body 1, a rotating shaft of the eccentric weight 5 and a rotating shaft of the motor 8 are disposed to form one line, and the whole of the constitution is placed on a common frame 10 and supported on a base 12 by a spring 11. The weight of the vibrating body 1 and the motor 8 and the distance to the eccentric weight 5 are so adjusted as to conform the whole of center of gravity with the center of the vibration force of the eccentric weight 5.

CN 106732096 describes; A The invention discloses a test tube shaking device, and belongs to the field of experimental equipment. A middle part of the upper end of a base is fixedly connected with a vertical plate; an output shaft fixing hole is arranged in the vertical plate; a motor output shaft of the motor is sleeved with the output shaft fixing hole; the tail end of the motor output shaft is fixedly connected with one end of a crank; the other end of the crank is fixedly connected with one end of a connecting rod, the other end of the connecting rod is connected with a connection block on a test tube clamp through a connecting bolt; a test tube is clamped in the middle of the test tube clamp; an open end of the test tube is blocked by a test tube plug; a transverse track and a longitudinal track are arranged in the vertical plate; fixed magnets are arranged at four corners of the junction of the transverse track and the lon-gitudinal track; a reversing plate is arranged on each fixed magnet; a control box is arranged on the vertical plate. The transverse shaking or longitudinal shaking function of the test tube is achieved through the transverse track, the longitudinal track and a sliding column and the diversity of experiments is achieved.

CN 106732096 B describes; A test tube shaking device, belonging to the field of experimental equipment, the middle part of the upper end of the base is fixedly connected with the vertical plate, the vertical plate is provided with an output shaft fixing hole, and the motor output shaft of the motor is sleeved in the output shaft fixing hole, the end of the output shaft of the motor is fixedly connected to one end of the crank, the other end of the crank is fixedly connected to one end of the connecting rod, the other end of the connecting rod is connected to the connecting block on the test tube fixture through a connecting bolt, and the test tube A test tube is clamped in the middle of the clamp, and the open end of the test tube is blocked by a test tube stopper. A horizontal track and a longitudinal track are opened on the vertical plate, and fixed magnets are arranged on the four corners of the intersection of the horizontal track and the longitudinal track. A reversing plate is arranged on the fixed magnet, and a control box is arranged on the vertical plate; the device realizes the function of shaking the test tube horizontally or vertically through the horizontal and vertical rails and the sliding column, and realizes the diversity of experiments

WO 2008/103004 A1 describes; Disclosed herein is a drugs mixing device for vibrating and rotating a drug bottle containing two or more different drugs to mix the drugs. The drugs mixing device includes a drug bottle receiving unit, a device body, and an eccentric motor and a power supply source mounted in the device body. When the eccentric motor is energized with power supplied from the power supply source and thus generates vibration, the drug bottle, mounted in the drug bottle receiving unit, is vibrated and rotated by the generated vibration.

US 2007/0145067 A1 describes; A viscous fluid dispensing system and method of dispensing which includes a container mounted on a vibrating support. The container is normally the container from a blender in which a smoothie has been prepared. A motor drives an unbalanced weight which vibrates the container support. This fluidizes the viscous fluid in the container. The container, and the container support are pivoted.

GB 1057877 A describes; In a laboratory mixer, a work holder 1 with clamps 3, 4 for flasks 5 to be agitated is rigidly coupled with the stator 13 of an electric motor 14, means such as eccentric weights 16 being provided one at each end of the motor shaft 15 to cause the rotor of the motor to rotate out of balance. Resilient support means such as rubber or artificial rubber blocks 11, 17 respectively are provided between the upper part 9 of a housing 10 and a flange 7 on the holder 1, and between the lower part of the housing and a supporting surface 18 therefor.

CN 114558488 A describes; The invention provides a blending device, a blending method and a sample analyzer, the blending device comprises a limiting block, a gripper sliding block, a gripper assembly and a rotating shaft, the gripper sliding block is in clearance fit with the limiting block, the rotating shaft is in clearance sleeve connection with the gripper sliding block, and the auxiliary axis of the auxiliary shaft section of the rotating shaft is eccentrically arranged relative to the main axis of the main shaft section of the rotating shaft. The limiting groove is in clearance fit with the gripper sliding block, and the auxiliary axis of the auxiliary shaft section of the rotating shaft and the main axis of the main shaft section of the rotating shaft are eccentrically arranged; the gripper sliding block can be driven to rotate in the limiting piece according to a preset movement track when the rotating shaft rotates, so that peripheral blood test tubes or venous blood test tubes are linked to perform uniform mixing action,

CN 106139985 A describes; The invention relates to a high-efficiency sample oscillation and uniform mixing device and a use method. The high-efficiency sample oscillation and uniform mixing device comprises a base, four brackets, a sample frame and an eccentric motor vibration system; the upper part of the base is connected with the sample frame through the four brackets; the eccentric motor vibration system is po-sitioned in the middle part of the base, and is vertically arranged; the eccentric motor vibration system consists of a semi-cylindrical block with deflection of center of gravity, a bearing, a motor and a control system; the semi-cylindrical block with deflection of center of gravity is connected with the motor through the bearing, and the motor is electrically connected with the control system.

1. A mixing device comprising:
a rotating actuator carrying an eccentric load;
a controller exercising parameter control defining operation of the rotating actuator and instantaneous amounts of energy provided, to the mixing device through controlled rotation of the eccentric load;
a mount configured to hold securely the rotating actuator;
a clamp configured to hold a mixing container or a multiplicity of mixing containers, wherein the mixing container includes at least one liquid as part of assembled container contents;
a multi-element spring containing a plurality of structural elements connected to each other by an at least one connection, the at least one connection supporting a relative dynamic change in orientation between connected structural elements when under dynamic load, the multi-element spring including:
a principal structural element having a proximal end and a distal end, wherein the mount and rotating actuator are securely coupled substantially at or towards the proximal end;
a support structural element interposed between the distal end of the principal structural element and the clamp, the support structural element both extending relatively outwardly from the principal structural element and in a different orientation relative to the orientation of the principal structural element and wherein the clamp is affixed to the support structural element, the clamp is fixed such as to hold, in use, the mixing container securely into the mixing device;
a reference structural element connected, through a first connection, to a part of the principal structural element, the reference beam both extending relatively outwardly from the principal structural element and in a different orientation relative to an orientation of the principal structural element, wherein the reference structural element has a shape designed to permit, when in use and further connected to a stable bracing structure, differing amounts of flexion movement relative to the stable bracing structure.

2. The mixing device of claim 1, wherein the multi-element spring does not include a support structural element and wherein at or towards the distal end of the principal structural element, the clamp is fixed such as to hold, in use, the mixing container securely into the mixing device.

3. The mixing device of any preceding claim, wherein at least two of:
the principal structural element;
the reference structural element;
the clamp;
the mount; and
the mixing container; are formed in a unitary construction.

4. The mixing device of any preceding claim, wherein the controller is arranged to operate to control delivery of energy to the mixing device, as delivered by operation of the rotating actuator, that has a function that includes at least one of:
delivering a constant energy;
delivering a linear variation in energy;
delivering an exponential variation in energy; and
delivering a non-linear variation in energy.

5. The mixing device of any preceding claim, wherein at least one of the plurality of structural elements includes one or more of material relief of varying geometry.

6. The mixing device of any preceding claim, wherein movement of the assembled container contents represents a secondary eccentric load inducing additional flexion movement through generation of dynamic bending forces within the multi-element spring arising from time-varying loads operating at the proximal end and distal end of the principal structural element.

7. The mixing device of any of claims 1-5 and a sealed container realising the mixing container, wherein the sealed container is internally sterile and contains a sterile compound to be dissolved, diluted or suspended in or by a sterile diluent introduced into the container by means of seal penetration.

8. The mixing device of any preceding claim, wherein combined resultant forces within the mixing device arising from controlled operation thereof cause the mixing container to move in an approximately predictable cyclical trajectory.

9. The mixing device of any preceding claim, wherein the controller is arranged controllably to establish production of a vortex-like effect within the container contents, said vortex-like effect arising as a state approximating system resonance is approached by mechanical interaction between components within the mixing device.

10. The mixing device of claims 1-7, wherein the controller is arranged to instantiate an initial phase that induces a chaotic motion by shaking the assembled container contents in the attached mixing container.

11. A method of dissolving or diluting or suspending a compound with a diluent introduced into a mixing container held securely by a clamp of a mixing device, the method comprising:
securing the mixing container to the clamp, wherein the mixing container includes a combination of a diluent and a compound that produce a mixture;
initially shaking or swirling the mixture by dynamically flexing multiple elements of a multi-element spring in different planes of motion, said flexing initially caused by a rotation of a first eccentric load by a rotating actuator that is securely fixed in a mount at a first end of a principal structural element of the multi-element spring, said shaking or swirling of the mixture resulting from multi-plane flexing of the principal structural element being connected by at least a first connection to a reference structural element and wherein the reference structural element further is arranged to flex relative to a stable bracing structure;
using a microprocessor-based controller to control operation of the rotating actuator, thereby to deliver instantaneous amounts of energy to the mixing device through controlled rotation of the first eccentric load;
inducing, by action of said rotation of the first eccentric load, a complementary secondary flexing in the multi-element spring through induced swirling or shaking of the mixture, wherein the complementary secondary flexing produces a spatially distant second eccentric load at the mixing container, and wherein the mixing container is held securely by the clamp on a support structural element connected to the distal end of the principal structural element.

12. The method of claim 11, wherein the support structural element is not included between the distal end of the principal structural element and the clamp wherein the principal beam is arranged to mount a clamp for the container and further arranged to mount, remotely from the clamp, the first eccentric load.

13. A processor-controlled mixing system for mixing or dissolving one or more ingredient(s) or compounds with a liquid, the system comprising:
a motor having a rotor;
a processor arranged to control delivery of energy to the system by controlled operation of the motor;
a container holding said one or more ingredient(s) or compounds and the liquid; and
a plurality of beams each interconnected by a substantially rigid connection wherein a combination of beams and connections form a multi-element spring in which, under applied motor-induced forces, at least some of said plurality of beams flex or bend in one or more planes of motion, and some of said plurality of beams undergo relative angular displacement or relative linear displacement in differing planes of motion for said beams; and
first and second eccentric loads located remote from each other but attached to the multi-element spring, wherein:
the first eccentric load is an eccentric mass on the rotor of the motor;
and the second eccentric load is created by agitation of said one or more ingredient(s) or compounds and the liquid in the container, said agitation following flexing and displacement of the plurality of beams responsive to motor-induced forces introduced into the multi-element spring by controlled operation of the motor by the processor.

14. The system of claim 13 wherein the plurality of beams includes the reference beam and at least the principal beam, wherein the principal beam is arranged to mount a clamp for the container and further arranged to mount, remotely from the clamp, the first eccentric load.

15. The system of claim 14, wherein the plurality of beams further include a support beam, said support beam being a third beam coupled to an end of the principal beam and arranged to mount the clamp.
